(19) United States
(12) Patent Application Publication
(10) Pub. No.: US 2026/0117734 A1
(43) Pub. Date: Apr. 30, 2026

(54) MAGNETICALLY ROTATING SPARK PLUG WITH SLANTED COAXIAL ELECTRODE

(71) Applicants: Hyundai Motor Company, SEOCHO-GUSEOUL (KR); King Abdullah University of Science and Tech., Thuwal-Jeddah (SA); Saudi Aramco Technologies Company, Dhahran (SA)

(72) Inventors: Hyunjin Kang, Hwaseong-si (KR); Jonghyeok Lee, Hwaseong-si (KR); Dong Hee Han, Hwaseong-si (KR); Abdullah S. AlRamadan, Dhahran (SA); Sun Ho Park, Thuwal-Jeddah (SA); Min Suk Cha, Thuwal-Jeddah (SA)

(73) Assignees: Hyundai Motor Company, SEOCHO-GUSEOUL (KR); King Abdullah University of Science and Tech., Thuwal-Jeddah (SA); Saudi Aramco Technologies Company, Dhahran (SA)

(21) Appl. No.: 19/202,860

(22) Filed: May 8, 2025

(30) Foreign Application Priority Data
Oct. 25, 2024 (KR) 10-2024-0147213

(51) Int. Cl. F02P 9/00; F02P 15/00

(52) U.S. Cl. CPC F02P 9/002; F02P 15/006

(57) ABSTRACT

Systems and methods for spark ignition in a combustion engine are provided. The spark ignition system includes a terminal, a magnetic body, an insulating body, and a grounding body. The spark ignition system further includes a center electrode electrically connected to the terminal and protruding into a combustion chamber. The grounding body includes a body section and an inclined section. The spark ignition engine includes a combustion chamber and a spark ignition system. The method includes applying a voltage to a spark ignition system, thereby generating a spark.

### BACKGROUND

As the automobile industry seeks to comply with increasing regulations pertaining to carbon dioxide and nitrogen oxide emissions, there is an increasing interest in lean combustion technology for enhanced fuel efficiency. Lean combustion burns fuel with an excess of air, i.e., a lean-burn mixture, resulting in a much lower fuel-to-air ratio and lower combustion temperatures compared to standard gasoline combustion. In addition to significantly lowering gas emissions, lean combustion makes it possible to achieve high thermal efficiency, mainly by reducing pumping and heat losses.

Lean combustion is difficult to perform in spark ignition engines because spark ignition systems, such as spark plugs, are not always able to ignite lean fuel-air mixtures. In some cases, standard spark plugs are unable to provide a strong enough discharge arc to burn a lean-burn mixture, resulting in a misfire or no-burn condition in the engine. Even in cases where the spark plug is able to ignite the lean-burn mixture, the resulting flame may fail to propagate from the ignition site, resulting in a no-burn condition in the engine. Accordingly, there exists a need for advancements in lean combustion technology relating to spark ignition systems and spark ignition engines.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a spark ignition system. The spark ignition system comprises a terminal configured to receive power and a center electrode electrically connected to the terminal and protruding into a combustion chamber. The spark ignition system further comprises an insulating body configured to insulate the center electrode, a magnetic body configured to generate a magnetic force, and a grounding body configured to generate a spark discharge. The grounding body comprises a body section and an inclined section. The grounding body is further configured to transmit the magnetic force generated by the magnetic body to the spark discharge, thereby rotating the generated spark discharge.

In another aspect, embodiments disclosed herein relate to a spark ignition engine. The spark ignition engine comprises a combustion chamber and a spark ignition system inside the combustion chamber. The combustion chamber comprises a cylinder block and a cylinder head.

In yet another aspect, embodiments disclosed herein relate to a method for generating a spark in a spark ignition system. The method comprises applying a voltage to the spark ignition system, thereby generating the spark. The spark ignition system comprises a terminal that receives power and a center electrode electrically connected to the terminal and protruding into a combustion chamber. The spark ignition system further comprises an insulating body, a magnetic body, a plurality of coolant channels, and a grounding body. In one aspect, embodiments disclosed herein relate to the method further comprising flowing a coolant through the plurality of coolant channels, thereby cooling the magnetic body.

Any combinations of the various embodiments and implementations disclosed herein can be used in a further embodiment, consistent with the disclosure. Other aspects and advantages of the claimed subject matter will be apparent from the following description and the appended claims.

### BRIEF DESCRIPTION OF DRAWINGS

These drawings are for reference only in explaining exemplary embodiments of the present disclosure, and therefore, the technical ideas of the present disclosure should not be interpreted as being limited to the attached drawings.

FIG. 1 is a cross-sectional view of a spark ignition engine according to one or more embodiments.

FIG. 2 is a side view of a spark ignition system according to one or more embodiments.

FIG. 3 is a cross-sectional view of a spark ignition system according to one or more embodiments.

FIG. 4 is a side view of a spark ignition system according to one or more embodiments.

FIG. 5 is a side view of a spark ignition system according to one or more embodiments.

FIGS. 6A-6G are side views of a spark ignition system according to one or more embodiments.

FIG. 7 is a bottom view of a spark ignition system according to one or more embodiments.

FIG. 8 is a bottom view of a spark ignition system according to one or more embodiments.

FIGS. 9A and 9B are side views of a spark ignition system according to one or more embodiments.

FIG. 10A is a bottom view of a spark ignition system according to one or more embodiments.

FIG. 10B shows perspective views of a spark ignition system part according to one or more embodiments.

FIGS. 11A and 11B are plots showing magnetic flux density according to one or more embodiments.

FIG. 12 is a chart of elongation times according to one or more embodiments.

FIG. 13 is a chart of air excess ratios according to one or more embodiments.

FIG. 14 is a chart showing elongated speed of a spark length according to one or more embodiments.

FIG. 15 is a chart of estimated spark lengths according to one or more embodiments.

FIGS. 16A and 16B are charts showing times to reach maximum spark length according to one or more embodiments.

FIGS. 17A and 17B are charts showing times to reach maximum spark length according to one or more embodiments.

FIG. 18 is a chart of air excess ratios according to one or more embodiments.

FIG. 19 is a flowchart of a method according to one or more embodiments.

### DETAILED DESCRIPTION

Embodiments disclosed herein generally relate to a spark ignition system, a spark ignition engine, and a method for cooling a magnetic body in a spark ignition system. A spark ignition system and a spark ignition engine include a spark plug.

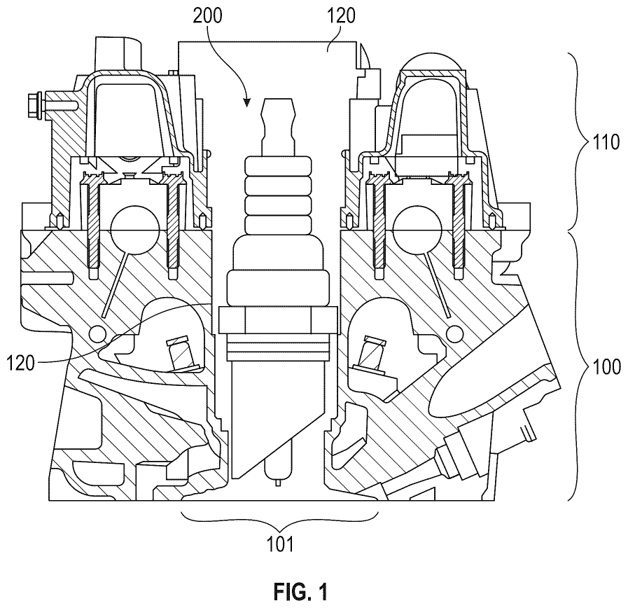

FIG. 1 is a cross-sectional view showing a spark ignition engine according to one or more embodiments. As shown in FIG. 1, a spark ignition engine includes a cylinder block 110, cylinder head 100, and spark ignition system 200. The cylinder head 100 extends downward through a mounting hole 120 in which a spark ignition system 200 is mounted. A combustion chamber 101 is formed at a lower end of the spark ignition system 200.

When the spark ignition engine is activated, a mixture of air and fuel flowing into the combustion chamber 101 is ignited by a spark discharge generated from a spark ignition system 200. If the spark ignition engine remains activated, the spark discharge and resulting ignition may continue.

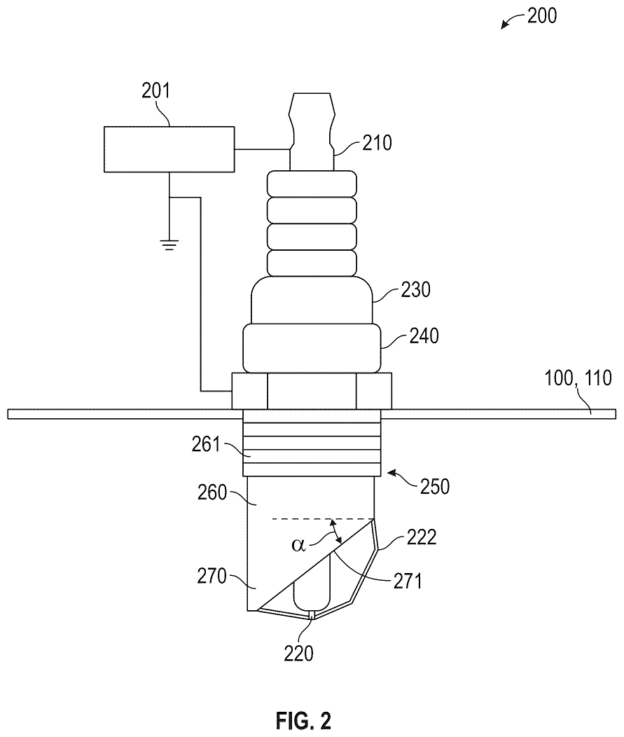

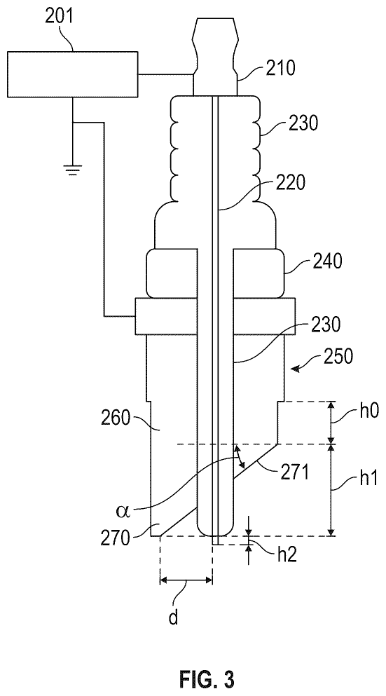

FIG. 2 and FIG. 3 show spark ignition systems in accordance with one or more embodiments. A spark ignition system 200 includes a terminal 210. The terminal 210 is configured to receive power from a high voltage system 201 equipped in the vehicle. The terminal 210 is mounted in the mounting hole 120 and is configured to supply a high voltage current to a center electrode 220.

The center electrode 220 is located adjacent to an end of the terminal 210 and protrudes into the combustion chamber 101. The center electrode 220 has a longitudinal axis extending from the terminal 210 to the combustion chamber 101. The center electrode is electrically connected to the terminal 210.

A spark ignition system 200 in accordance with one or more embodiments also includes an insulating body 230, magnetic body 240, and grounding body 250. In one or more embodiments, the insulating body 230, magnetic body 240, and grounding body 250, are radially disposed around the center electrode 220 and may have radial symmetry about the longitudinal axis of the center electrode 220. Together, the insulating body 230, magnetic body 240, and grounding body 250 may function as a coaxial electrode.

The insulating body 230 is located adjacent to an end of the terminal 210. The insulating body 230 is configured to insulate the center electrode 220 and prevent discharge from occurring on the side of the center electrode 220. For example, the insulating body 230 may surround and radially encase the center electrode 220. The insulating body (230) may be formed of a ceramic material, such as alumina ceramic.

The magnetic body 240 radially encases, partially or completely, the insulating body 230. The magnetic body is configured to generate a magnetic field. The magnetic field results in a magnetic force. The magnetic force is transmitted through the grounding body 250 and rotates a spark discharge occurring between the center electrode 220 and the grounding body 250.

In one or more embodiments, the magnetic body 240 may be a ring-shaped magnet. The magnetic body 240 can be a permanent magnet, such as neodymium, or an electromagnet having a Curie temperature range of 583 to 673K. While the engine is operating, the surface temperature of a spark plug reaches about 770K, which is higher than the Curie temperature of most magnets. If the magnetic body 240 is subject to temperatures higher than the Curie temperature, the magnetic properties may be lost and the magnetic flux density may become close to 0. In one or more embodiments, the magnetic body 240 may be located outside the combustion chamber 101, in the cylinder of the vehicle, to prevent it from reaching or exceeding the Curie temperature.

If a permanent magnet is used for the magnetic body 240, the spark ignition system 200 may activate upon the application of a high voltage current to the spark ignition system 200. If an electromagnet is used for the magnetic body 240, one or more additional steps may be required to activate the spark ignition system 200. For example, the electromagnet may be activated before the spark ignition system 200 is activated, using a method such as the application of a current directly to the electromagnet.

The grounding body 250 is located adjacent to an end of the magnetic body 240 and radially encases, partially or completely, the insulating body 230. The grounding body 250 may be cylindrical. The grounding body 250 may be formed of a metal material with a permeability high enough to transmit the magnetic force generated by the magnetic body 240. Additionally, the grounding body material may be selected to have a Curie temperature higher than the surface temperature of a typical spark plug. For example, the grounding body 250 may be made of iron or S45C stainless steel.

The grounding body 250 includes a body section 260 and an inclined section 270. The bottom surface of the inclined section 270 is an inclined surface 271. The body section 260 has radial symmetry about the longitudinal axis of the center electrode 220. The inclined surface 271 may be smooth or may have a rough texture. The degree to which the inclined surface 271 is inclined (i.e., the tilt of the inclined surface 271 relative to the vertical axis) may be referred to as the slanted angle, labeled as a in FIG. 2.

In general, three geometric configurations of the inclined surface 271 may be achieved. First, an inclined slanted geometry may be achieved using a slanted angle greater than 0° and less than 90°. Second, a flat geometry may be achieved using a slanted angle of 90°. Third, a declined slanted geometry may be achieved using an angle greater than 90° and less than 180°. In one or more embodiments, a slanted angle between 0° and 90° may be selected. For example, in one or more embodiments, the slanted angle may be 1°, 5°, 7°, 10°, 15°, 20°, 21°, 25°, 30°, 32°, 35°, 40°, 45°, 50°, 55°, 60°, 65°, 70°, 75°, 80°, 85°, or 89°.

In one or more embodiments, the inclination may vary around the circumference of the inclined section 270. For example, the inclined surface 271 may appear slanted from a side view of the spark ignition system, as shown in FIG. 2 and FIG. 3, due to the inclination on one side of the center electrode 220 mirroring the inclination on the other side of the center electrode 220.

A spark discharge may occur between the inclined section (270) of the grounding body 250 and the end of the center electrode 220. For example, a spark discharge may occur within a shortest distance between the exposed end of the center electrode 220 and the inclined section 270, i.e., the shortest interelectrode gap.

FIG. 2 is a side view of a spark ignition system 200. A spark channel 222 is shown extending from the center electrode 220 to two points along the inclined surface 271. As shown, the grounding body 250 may be attached to the cylinder block 110 or cylinder head 100. For example, and as shown in FIG. 2, the grounding body 250 may include a screw section 261. The screw section 261 may include a hex and a screw thread, such that the screw thread connects to a screw tap in the cylinder block 110 or cylinder head 100.

FIG. 3 is a cross-sectional view of a spark ignition system 200. In one or more embodiments, the insulating body 230 has one or more ridges along an outer circumference above the magnetic body 240 or be made of one or more ring-shaped parts. As shown in FIG. 3, the insulating body 230 may extend through the magnetic body 240 and the grounding body 250.

The body section 260 of the grounding body 250 has a height h0 and the inclined section 270 of the grounding body 250 has a height h1. The insulating body 230 extends to the axial end of the inclined section 270. The center electrode 220 extends to a height of h2 past the insulating body 230.

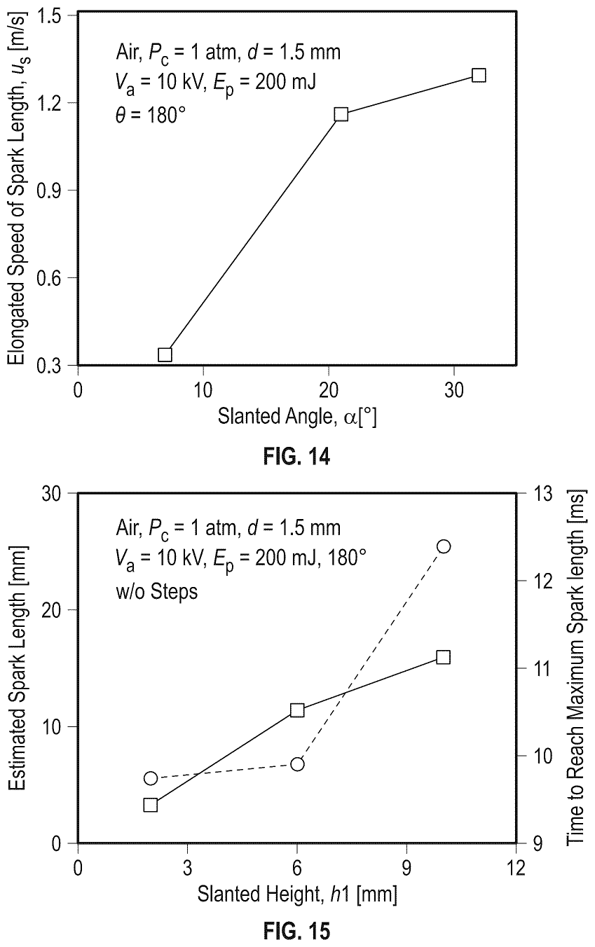

Height h0 affects the transmission distance of the magnet flux from the magnetic body 240 to the inclined surface 271. A shorter h0 reduces the magnetic flux path length, thereby minimizing magnetic field losses. Height h1 affects the behavior of a spark generated using the spark ignition system 200, as discussed in FIGS. 14 and 15. Height h2 affects the interactions between the insulating body 230 and a spark generated using the spark ignition system 200. A longer h2 minimizes these interactions.

When the spark ignition system 200 is activated by passing a current through the center electrode 220, a spark discharge first occurs within the shortest interelectrode gap, shown as distance d in FIG. 3. The spark discharge may rotate due to the magnetic force generated by the magnetic body 240. As the spark discharge rotates, it may gradually move along the inclined surface 271. Accordingly, the spark discharge may elongate as it rotates. The path of an elongated spark discharge is referred to herein as a spark channel, such as the spark channel 222 shown in FIG. 2.

If the slanted angle α of the inclined section 270 increases, h1 increases. Accordingly, the spark channel length may also increase. Therefore, an increase in slanted angle increases the spark channel length limit.

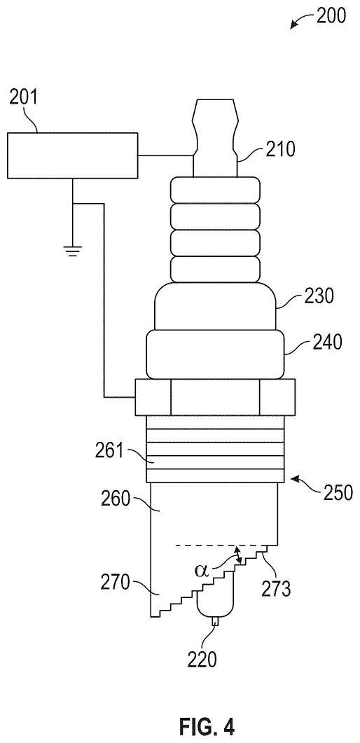

FIG. 4 is a side view of a spark ignition system 200 in accordance with one or more embodiments. The inclined surface 271 is shown in FIG. 4 as having a slanted angle α and steps 273. When the spark ignition system 200 is activated, the motion of a spark discharge may be affected by the presence of one or more steps along the inclined surface 271. For example, by forming many steps on the inclined surface 271, the rotation speed of the spark discharge generated between the center electrode 220 and the grounding body 250 may be increased. A sufficiently large step height, such as 2.5 mm, may be needed to increase the rotation speed of the spark discharge. However, too large of a step height may hinder the rotation speed of the spark discharge.

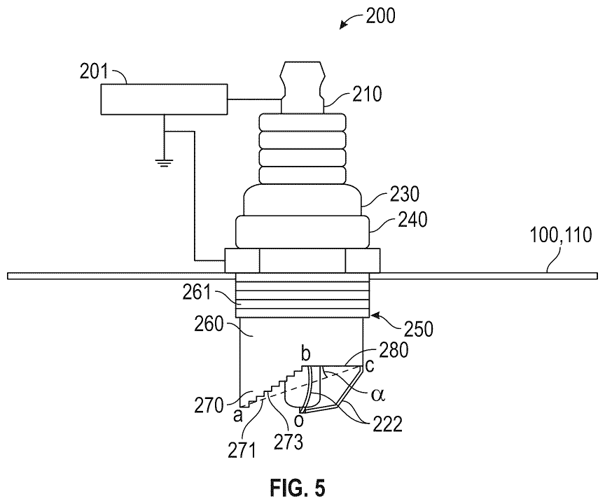

FIG. 5 is a side view of a spark ignition system 200 in accordance with one or more embodiments. The grounding body 250 is shown to have four sections: a screw section 261, a body section 260, a straight section 280, and an inclined section 270. The screw section 261 and body section 260 radially encase an insulating body 230. The straight section 280 is perpendicular to the axial direction of the body section 260 and forms a circumference together with the inclined section 270. Accordingly, the inclined surface 271 of the inclined section 270 may extend only partially around a circumference of the grounding body 250. For example, as shown in FIG. 5, the inclined surface 271 of inclined section 270 may extend at least from point a to point b.

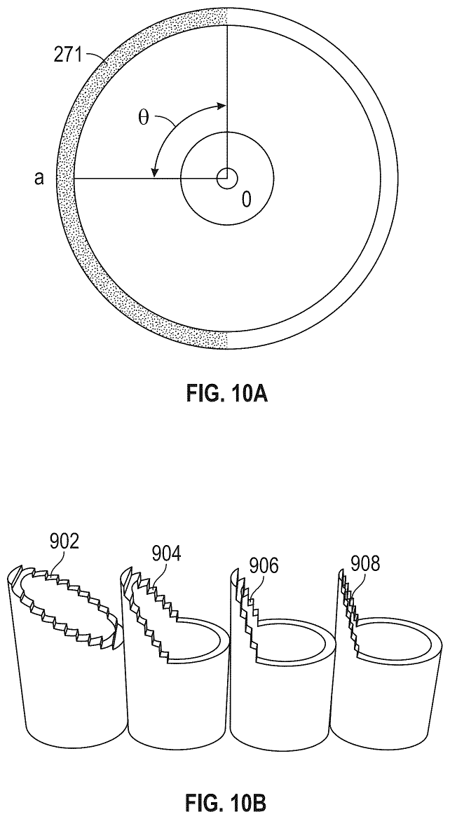

When the inclined section 270 extends partially, rather than fully, around a circumference of the grounding body 250, a steeper slope of the inclined section 270 may be achieved. When the slanted angle of the inclined section remains constant or, for example, ranges from 30° and 45°, the steeper appearance of the slope of the inclined section 270 may result at least partially from a reduction in the azimuthal angle covered by the inclined section 270. The formation angle (θ) is half angle of the azimuthal angle, and the formation angle may range from 30° and 90°. Additional details regarding the formation angle (θ) are provided with the description of FIGS. 10A and 10B in subsequent sections.

As the slope of the inclined surface 271 becomes steeper, the length of the spark channel may increase more rapidly during a given rotation in which the spark ignition system 200 is activated. Furthermore, the steeper slope of the inclined section 270 may allow the spark channel to elongate more rapidly within the limited time imposed by engine operating conditions, such as engine speed and engine load.

A spark channel 222 is illustrated in FIG. 5. An “ob” section of the spark channel 222 extends from an end of the center electrode, i.e., point o, to a step 273 closest to the body section 260 of the grounding body 250, i.e., point b. An “oc” section of the spark channel 222 extends from an end of the center electrode, i.e., point o, to a point along the straight section 280, i.e., point c. The lengths of the “ob” and “oc” spark channels may be similar. As the slanted angle (α) of the inclined section 270 decreases, the lengths of spark channels “ob” and “oc” would decrease. However, a change in the both of slanted angle (α) and formation angle (θ) would not result in a change to the distance from point o to point a.

To operate the spark ignition system 200 shown in FIG. 5, a high voltage is first applied from the high voltage system 201 to the terminal 210. The high voltage causes a spark discharge at the shortest interelectrode gap, i.e., the distance from point o to point a. Due to the vertical magnetic flux density from the magnet, the initial spark rotates along the inclined surface 271 of the step-embedded inclined section 270. As the spark rotates along an edge of the inclination surface, the spark reaches a maximum length along the “ob” section of the spark channel 222. As the spark continues to rotate around the straight section 280, the spark length, now defined by the “oc” section of the spark channel 222, is comparable to the “ob” section of the spark channel 222.

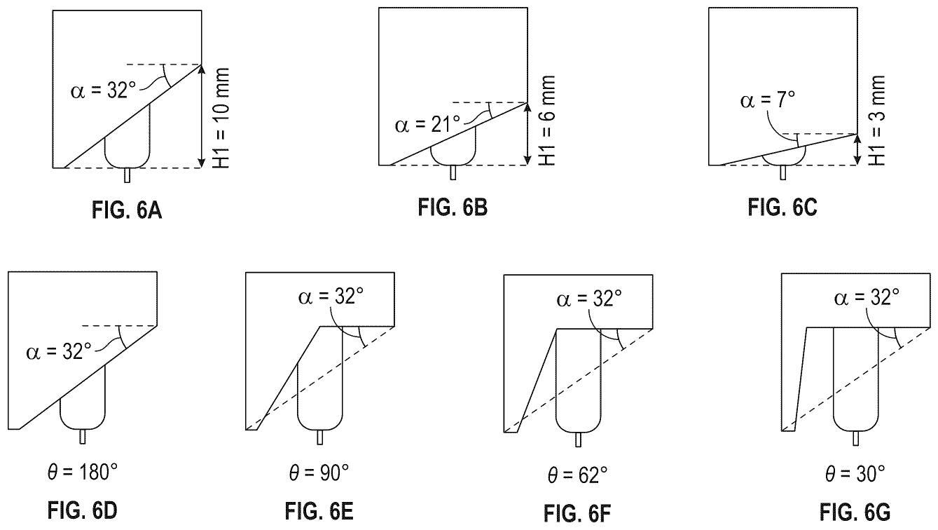

Embodiments showing different variations in slanted angle (α) and formation angle (θ) are shown in FIGS. 6A-6G. In FIGS. 6A-6C, the formation angle is held constant at 180° while the slanted angle is varied. The slanted angle (α) is shown as 32° in FIG. 6A, 21° in FIG. 6B, and 7° in FIG. 6C. The height h1 is shown to decrease with a decreasing slanted angle, starting at 10 mm in FIG. 6A and decreasing to 3 mm in FIG. 6C.

In FIGS. 6D-6G, the slanted angle is held constant at 32° while the formation angle is varied. The formation angle (θ) is shown as 180° in FIG. 6D, 90° in FIG. 6E, 62° in FIG. 6F, and 30° in FIG. 6G.

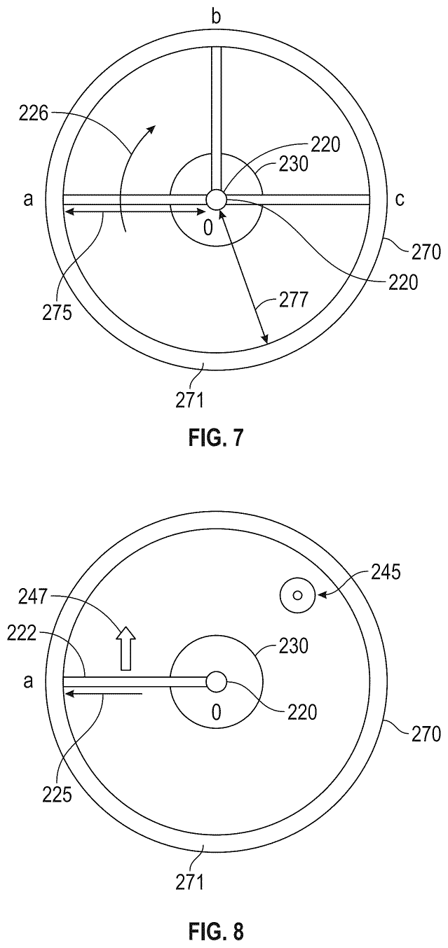

FIG. 7 is a bottom view of a spark ignition system 200 according to one or more embodiments. When a high voltage is applied to the terminal 210 and travels through the center electrode 220, an electrical current 225 flows between the end of the center electrode 220 and the inner surface of the grounding body 250. For example, an electrical current may flow along path “oa,” i.e., the shortest interelectrode gap. Path “oa” may also be a first section 275 of a spark channel for a spark discharge. As the spark discharge rotates around the inclined surface 271, current may flow along another path, such as a second section 277.

In FIG. 7, spark channel sections “oa,” “ob,” and “oc” can be seen to have the same radial length. An inclined surface 271 of inclined section 270 is shown radially encasing insulating body 230 and center electrode 220.

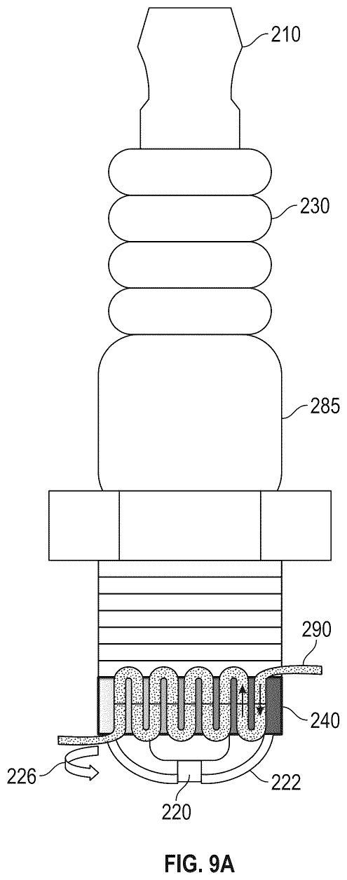

FIG. 8 is a bottom view of a spark ignition system 200 in accordance with one or more embodiments. In addition to the electrical current 225, a spark discharge may be affected by a magnetic field. For example, a magnetic force 245 passing from the magnetic body (240) to the grounding body (250) in FIG. 8 extends into the drawing. Accordingly, the electromagnetic force, i.e., the Lorenz force 247, applied to a spark discharge in FIG. 8 is in a clockwise direction. Therefore, the spark channel 222 rotates clockwise. The direction of the electromagnetic force may be changed by changing the direction of the current or the direction of the magnetic field. Additionally, the rotation speed of the spark channel can be increased by increasing the current or increasing the magnetic flux.

If the distance between an end of the center electrode 220 and the inclined surface 271 changes around the circumference, the extension length of the spark channel will gradually increase as the spark channel rotates along the inclined surface 271. The increase in spark channel length may result in a lean-burn mixture within the combustion chamber 101 igniting. In one or more embodiments, a rapid increase in the length of the spark channel may result in a more accurate ignition timing of the lean-burn mixture. As discussed in FIGS. 4 and 5, the length of the spark channel may be increased more rapidly by including steps 273 in the inclined surface 271, by increasing slanted angle (α), and by decreasing formation angle (θ) of the inclined section 270.

To achieve the required electromagnetic force using conventional 12 and 48 V ignition coils, a maximum spark length must be achieved within 2 millisecond (ms) at 17 bar.

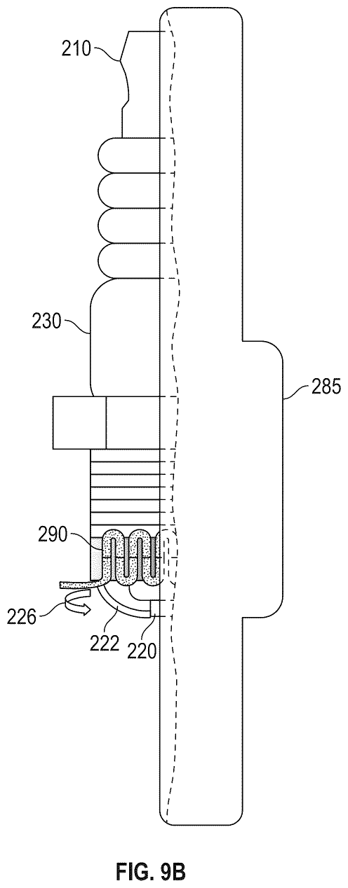

FIGS. 9A and 9B are side views of a spark ignition system 200 in accordance with one or more embodiments. A rotating and extended spark, rotating in direction 226, is shown as a spark channel 222.

Additional components may be added to the spark ignition system 200 to improve the performance of the system. In one or more embodiments, and as shown in FIGS. 9A and 9B, the spark ignition system 200 includes coolant channels 290 disposed around the magnetic body 240. In one or more embodiments, the coolant channels 290 may be within the magnetic body 240 and do not come into direct contact with other parts of the spark ignition system 200 (not shown). Coolant channels 290 may be designed to direct a flow of coolant to cool the magnetic materials, thereby mitigating the adverse effects of increased temperature on the effectiveness of the magnetic field. The coolant channels 290 may be insulated, similarly to heat exchangers. The coolant channels may be made of high temperature ceramic composites, non-magnetic stainless steel, or high-performance polymers, as is understood by those skilled in the art.

The coolant inlet and outlet may be in fluid communication with the engine's existing coolant circuit. For example, coolant may be scavenged from the engine head, routed to the area of the magnetic body most exposed to combustion heat (such as near the exposed end of the spark ignition system 200), then returned to the engine cooling system. In one or more embodiments, the coolant may be the same as the engine coolant, which is typically a water-glycol mixture. Alternatively, a dielectric coolant with electrical insulation, such as those used in EV motors, may be used.

The coolant may be continuously flowed through the coolant channels 290 throughout engine operation. In one or more embodiments, there may be instances at the engine start-up during which cooling could hinder the build up of hot charge and, hence, the flow of coolant may be delayed or paused.

FIG. 9B shows a cutaway view of a spark ignition system 200 surrounded by a damper 285. The damper 285 may be used to prevent direct transmission of electromagnetic waves and vibrations from the engine structure. This integration may enhance the robustness of the spark ignition system 200 by bolstering its resistance to electromagnetic interference arising from the Engine Control Unit (ECU) and ignition coil. The damper 285 may also diminish or eliminate vibrations associated with transient engine operation. A damper 285 may, for example, include one or more insulated isolation mounts.

The damper 285 may be positioned between the spark ignition system 200 and the engine structure in accordance with one or more embodiments. The damper 285 may additionally surround the thread in the engine cylinder head. In FIG. 9B, for example, a cutaway view shows the damper 285 fully surrounding the spark ignition system 200. A suitable damper 285 may resist heat from the engine, absorb vibrations, withstand electromagnetic fields, and withstand exposure to oils and combustion gases. A damper may, for example, be made using high temperature elastomers, e.g., silicone rubber, ceramic composites, thermoset polymers, or metallic mesh-filled elastomers.

FIG. 10A is a bottom view of a spark ignition system 200 according to one or more embodiments. A formation angle (θ) of the inclined surface 271 is shown relative to path “oa.” For example, in FIG. 10A the formation angle (θ) is 90°. The formation angle (θ) is half of the azimuthal angle of the inclined surface 271. The azimuthal angle of the inclined surface 271 is shown as the shaded section of inclined surface 271.

As the formation angle of the inclined surface 271 decreases, the width of the inclined surface 271 also decreases. As a result, the slanted surface becomes narrower, enhancing raid elongation of the spark channel.

FIG. 10B shows an inclined surface with various formation angles according to one or more embodiments. The formation angle for inclined surface 902 is 180°, the formation angle for inclined surface 904 is 90°, the formation angle for inclined surface 906 is 62°, and the formation angle for inclined surface 908 is 30°. The width of the inclined surface 271 can be seen decreasing from left to right in FIG. 10B.

### EXAMPLES

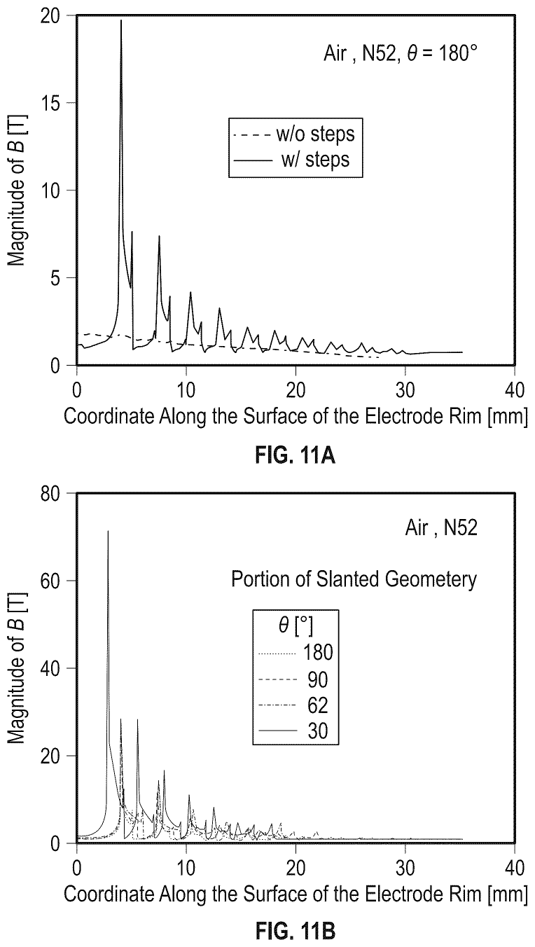

FIGS. 11A and 11B show simulation results for the magnetic flux density (the magnitude of magnetic field B with units of Tesla [T]) generated along the surface of the electrode rim as a spark channel rotates in accordance with one or more embodiments.

In FIG. 11A, a solid line shows the results for a spark ignition system 200 with ten steps formed in the inclined section 270. A dashed line shows the results for a spark ignition system without steps formed in the inclined section 270. The magnetic flux density forms a sharp peak at the edge of each step 273. Additionally, the magnetic flux density reaches a very high value at the beginning of rotation due to the edge of the step 273. The magnetic lines transmitted from the magnetic body 240 tend to concentrate at the first edge, resulting in a higher magnetic field strength at the first step compared to subsequent steps along the outer edge.

In FIG. 11B, the results are plotted as follows: the dash-dot line shows the case where the formation angle of the inclined surface 271 is 30°, the double dashed line shows the case where the formation angle of the inclined surface 271 is 62°, the solid line shows the case where the formation angle of the inclined surface 271 is 90°, the dashed line shows the case where the formation angle of the inclined surface 271 is 180°.

The magnetic flux density in FIG. 11B increases as the formation angle (θ) decreases. This is because a smaller formation angle results in a reduced width of the slanted geometry, which leads to a concentration of magnetic flux and, consequently, an increase in magnetic flux density.

Based on the results shown in FIG. 11B, a change in the formation angle of the inclined section 270 may have two effects on the elongation of the spark channel. First, the elongation speed of the spark channel may increase due to a steeper inclination of the inclined section 270. Second, the rotation of the spark channel may increase due to an increase in magnetic flux density. A steeper inclined surface, a higher magnetic flux density, or a combination of both can significantly enhance the elongation of the spark channel and thereby promote ignition of the lean-burn mixtures.

In lean-burn spark ignition engines, the elongation of the spark generated by a conventional J-shaped spark plug relies on the tumble flow created by the in-cylinder motion of the injected fuel-air mixture. This tumble flow is influenced by engine conditions such as piston shape and the injection timing of the fuel and air mixture. To synchronize spark elongation by the tumble flow, the ignition timing must also be carefully adjusted. As a result, in conventional systems, spark elongation is dependent on tumble flow, which in turn depends on engine conditions. In contrast, the spark ignition system 200 magnetically elongates the spark. Therefore, it does not rely on tumble flow and is not affected by engine parameters such as piston geometry, ignition timing, or injection timing.

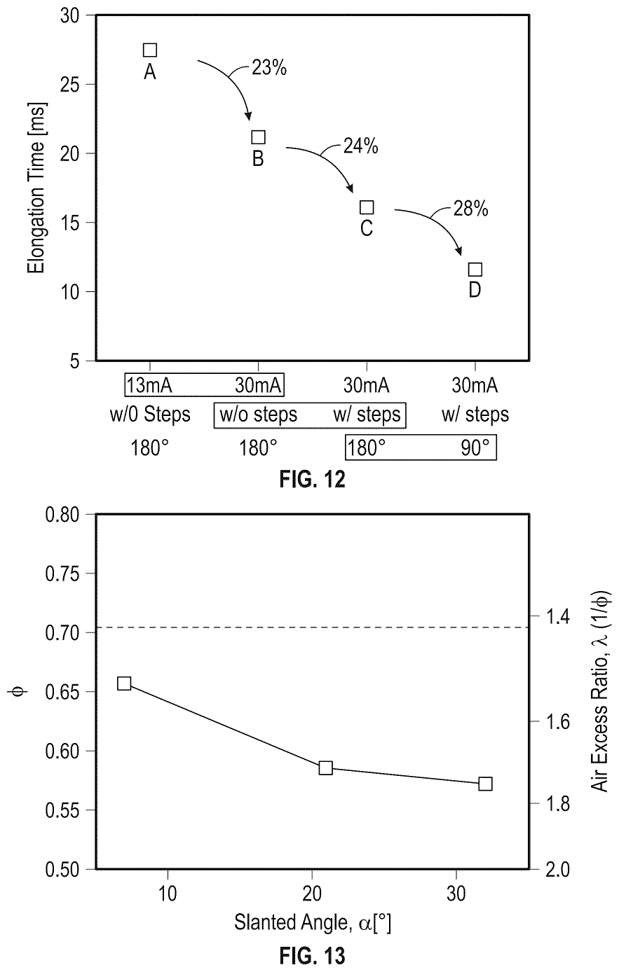

Experiments for the data shown in FIGS. 12-18 were performed using a pressurized constant-volume combustion chamber (CVCC) and a spark ignition system 200 in accordance with the embodiment described in FIG. 5.

The pressurized CV CC had a spherical inner geometry with a 300-mm diameter. Three optical windows, each 120 mm in diameter, were placed at three vertical faces of the CVCC. The CVCC had multiple ports to accommodate a vacuum and C₃H₈/air supply system, a high-voltage system, and a pressure measurement system. The CVCC pressure (P_{c}) was increased up to 1.96 atm due to the voltage limit of the high-voltage supply system. Three pressure conditions were considered: P_{c}=1.00, 1.40, and 1.96 atm, keeping the pressure ratio fixed at 1.4 for each increment (i.e., 1.40/1.00=1.4 and 1.96/1.40=1.4).

The spark ignition system 200 used for these experiments had a length of 168 millimeters (mm) and the center electrode 220 had a diameter of 2.8 mm. The magnetic body 240 was made of a ring-shaped N52 magnet (32-mm outer diameter, 12.7-mm inner diameter, 9.5-mm thickness, neodymium N52, ˜1.47 T). A grounding body 250 with a height of 25 mm, an outer diameter of 16 mm, and an inner diameter of 13 mm was used.

Some experiments included an inclined section 270 with steps and some experiments included an inclined section 270 without steps. The height of the inclined section 270 (h1 in FIG. 3) was varied between 3 and 10 millimeters (mm), resulting in a variation of the slanted angle from 7° to 32°. The formation angle (θ) was varied between 30° and 180°. The formation angle indicates a half angle of the slanted portion. Thus, θ=180 means whole edge is slanted, and θ=90 indicates only half of the azimuthal angle of the ground electrode is covered with the slanted geometry.

A voltage amplifier (Trek, 10/60 and 40/15), which amplified the pulse signal from a function generator (Keysight, 33600A), applied a pulsed high-voltage output to the terminal 210 of the spark ignition system 200. A delay generator (Stanford research system, DG535) communicated with the function generator to control the spark timing. Applied voltage (Vₐ) and current (I) were measured through a high-voltage probe (Tektronix, 6015A) and current probe (Tektronix, TCPA 300), respectively. The applied voltage and current were monitored by an oscilloscope (Tektronix, MSO 2024). An ignition energy (Eₚ) of 200 mJ was selected by changing the pulse duration (tₚ).

The dynamic pressure of the CVCC was measured by a pressure transducer (Keller, PAA-33X/80794), which was connected to a computer. A C₃H₈/air supply system and a lab vacuum system were connected at the CVCC. To test the physical characteristics of a spark discharge, only air was charged in the CVCC. To investigate the lean propagation limit, the equivalence ratio (φ) and air excess ratio (λ) were varied 0.53-0.62 and 1.61-1.89, respectively.

The spark ignition system 200 was horizontally installed at the center of a vertical plate inside the CV CC. An end of the center electrode 220 protruded 3.0 mm from the insulating body 230 into the CVCC. The spark discharge was generated in an interelectrode gap of 1.5 mm. The magnetic force from the magnetic body 240 rotates the spark and the slanted geometry of the inclined section 270 of the grounding body 250 causes the spark to elongate. The elongation of the spark may vary based on both the slanted height (h1 in the FIG. 3) and formation angle (θ). As discussed in the description of FIG. 3, the spark length reaches its geometrical maximum, determined by h1, as the spark rotates up to a selected θ.

The magnetic flux density and magnetic field line of a spark ignition system 200 with an inclined section 270 made of iron and a magnetic body 240 made of an N52 magnet (surrounded by air) were calculated using FEM M v.4-2 software. The magnetic field lines were found to extend from the lower surface the upper surface of the N52 magnet, and magnetic field lines were found to be orthogonal to the inclined section 270. Generally, the electromagnetic force (F_{emf}) acting on a spark channel can be explained by the following equation:

$${F}_{emf} = ( I \times B ) l$$

in which I is the current of the spark discharge, B is the magnetic flux density due to the ring-shaped permanent magnet, and l is the spark length. The following equation can be used to more accurately capture the electromagnetic force (F_{emf}) acting on a spark channel with a slanted geometry:

$${F}_{emf} = ( I \times B ) l sin ( {θ}_{IB} )$$

The angle θ_{IB} is the angle between the direction of the spark current and the magnetic flux density. Since the magnetic flux density is always orthogonal to the surface of the slanted geometry, θ_{IB} is consistently 90° within the region of the slanted geometry. From the equation, it can also be seen that the electromagnetic force may be maximized when θ is 90°, i.e., sin (θ_{IB})=1.

FIG. 12 is a chart comparing the time it takes for a spark channel of a spark ignition system 200 to extend to its maximum length, i.e., the elongation time, according to one or more embodiments.

In FIG. 12, examples A-D each represent an embodiment of a spark ignition system 200 with a slanted angle of 32°. Example A has an electrical current flowing between the center electrode 220 and the grounding body 250 of 13 milliamperes (mA), whereas examples B-D have a current flowing between the center electrode 220 and the grounding body 250 of 30 mA. Examples A and B do not include a step 273 in the inclined section 270, whereas examples C and D include at least one step 273 in the inclined surface 271. Finally, examples A-C have a formation angle of 180°, whereas example D has a formation angle of 90°.

In FIG. 12, the elongation time decreases from A to B, from B to C, and from C to D. These results indicate that a higher electrical current and, consequently, a higher Lorenz force, results in a more rapid elongation of the spark channel. For example, when the current flowing between the center electrode 220 and the grounding body 250 increases from 13 mA to 30 mA, the elongation time of the spark channel decreases by about 23%.

These results also indicate that the inclusion of at least one step 273 in the inclined section 270 results in a more rapid elongation of the spark channel. For example, the elongation time of the spark channel is reduced by about 24% between examples B and C. The edge of each step 273 may enhance the enhanced magnetic field, as described in FIGS. 11A and 11B, which may consequently increase the Lorenz force.

Finally, these results indicate that a smaller formation angle results in a more rapid elongation of the spark channel. For example, the elongation time of the spark channel is reduced by about 28% when the formation angle of the inclined surface 271 is changed from 180° to 90°. This effect may be due to the geometric structure of the inclined section 270, e.g., a more rapid change in the width the step 273 as the formation angle of the inclined surface 271 decreases.

FIG. 13 is a chart showing the limits of lean combustion of a spark ignition system 200 according to one or more embodiments. A slanted angle, α(°), is plotted on the horizontal axis. The slanted angle represents the angle of inclination of the inclined section 270 when the formation angle of the inclined surface 271 is 180 degrees.

An equivalence ratio (φ) is plotted as ascending values on the left vertical axis and an air excess ratio, λ (the inverse of φ), is plotted as descending values on the right vertical axis. The equivalence ratio is the mixing ratio of fuel and air expressed based on fuel, and air excess ratio is the mixing ratio of fuel and air expressed based on air. Theoretically, a perfect mixing ratio of fuel and air may be represented by an equivalence ratio equal to 1 and an air excess ratio equal to 1. Therefore, if the equivalence ratio is higher than 1, it may mean that the fuel ratio is high, and, conversely, if the equivalence ratio is less than 1, it may mean that the fuel ratio is low. Additionally, if the air excess ratio is higher than 1, it may mean that the air ratio is high, and, conversely, if the air excess ratio is less than 1, it may mean that the air ratio is low.

For lean combustion, it is desirable to use as little fuel as possible, i.e., an equivalence ratio less than 1 and an air excess ratio greater than 1. A lean combustion limit may be defined by the least amount of gas required in a fuel mixture to achieve combustion. In FIG. 13, combustion occurring at a lower equivalence ratio or a higher air excess ratio indicates a lower, and therefore more desirable, lean combustion limit.

The results in FIG. 13 correspond to three embodiments of the spark ignition system 200, each configured without the step 273 but including the magnetic body 240. The dashed horizontal line represents a reference case in which both the step 273 and the magnetic body 240 are absent. In the absence of the magnetic body 240, elongation of the spark channel does not occur. Accordingly, this case indicates the lean combustion limit under non-elongated spark conditions. The lean limits were obtained by applying a voltage of 10 kilovolts (kV) and an energy of 200 millijoules (mJ) to the shortest interelectrode gap of the ignition system.

As the slanted angle of the inclined section 270 increases, as shown along the horizontal axis, the limit of lean combustion lowers. That is, a leaner mixture of fuel and air can be burned when there is a greater inclination of the grounding body 250. Therefore, as the length of the spark channel increases, a leaner mixture may be combusted.

FIG. 14 is a chart showing the effect of slanted angle on spark elongation speed according to one or more embodiments. As shown in FIG. 14, the spark elongation speed initially increases as the slanted angle increases. However, as the slanted angle increases further, the rate of increase in elongation speed diminishes. Based on these results, a slanted angle in the range of approximately 30° to 45° is considered optimal for effective spark elongation. Therefore, it is advantageous for the inclined section to be inclined at an angle between 30° and 45°.

FIG. 15 is a chart showing the effect of slanted height (h1 in FIG. 3) on spark elongation according to one or more embodiments. The estimated spark length in millimeters (mm) is shown along the left vertical axis, and the time to reach the maximum spark length in milliseconds (ms) is shown along the right vertical axis. Results were found for various slanted heights plotted along the horizontal axis. All experiments were performed in air, at a pressure P_{c}=1 atm, interelectrode distance d=1.5 mm, voltage Vₐ=10 kV, energy Eₚ=200 mJ, and formation angle of 180° without steps. The spark length was calculated using the discharge voltage.

The estimated spark lengths are plotted as squares and the times to reach the maximum spark length are plotted as circles. For a 2-mm slanted height, the estimated spark length was found to be 3.3 mm and the time to reach the maximum spark length was found to be 9.7 ms. These values increased to 16 mm and 12.4 ms at a 10-mm slanted height, increasing 375% and 128%, respectively. These increases indicate that the spark length is more sensitive to slanted height as compared to the time to reach the maximum spark length.

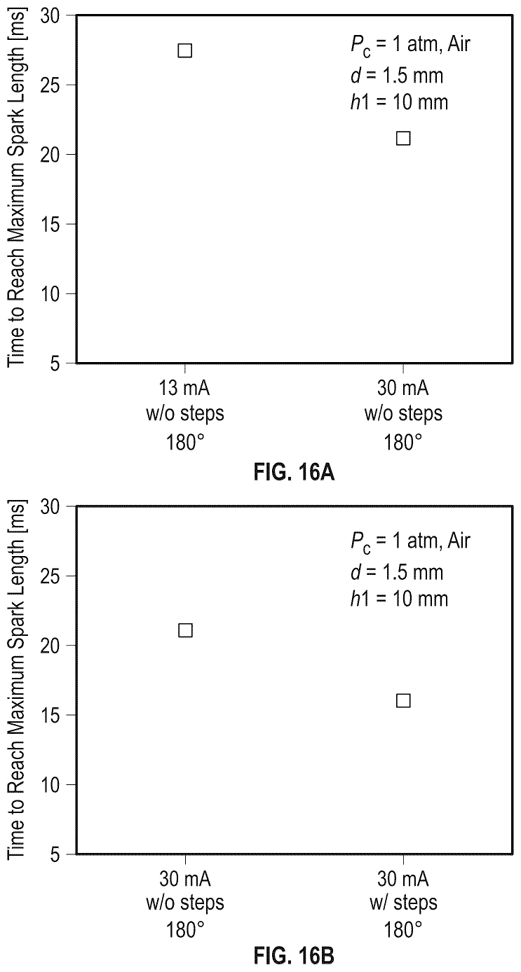

FIG. 16A is a chart showing the effect of current on the time to reach maximum spark length according to one or more embodiments. Two amplifiers were used to generate spark currents of 13 and 30 milliamps (mA). By increasing the current, the time to reach the maximum spark length was reduced from 27.4 to 21.1 ms. A current of 30 mA was selected for the following experiments.

FIG. 16B is a chart showing the effect of steps on the time to reach maximum spark length according to one or more embodiments. Two grounding bodies were tested, one with steps and one without steps. By adding steps, the time to reach the maximum spark length was reduced from 21.1 ms to 16 ms.

To further the investigation, the magnetic flux densities and magnetic field lines were calculated by COM SOL v-4.3 software. The simulation domain (200×200×200 mm³) included an inclined section 270 with steps and inclined section 270 without steps. Additionally, the simulation domain included an N52 magnet placed at the vertical center of the domain with surrounding air. The relative permeabilities are 383 (for a grounding body 250 made of S45C), 1.05 (for the N52 magnet), and 1.05 (for air). The number of grids is 3.28 M.

The magnetic flux density results showed peaks at the sharp edge of each step, as found in FIGS. 11A and 11B. The magnetic flux density in the early stage of the rotation of the spark reaches extremely high values due to the edges of the steps; since the magnetic field lines are concentrated at the edges of the steps, the magnetic flux density is strongest at these edges. A strong electromagnetic force was found to act on the spark channel in a spark ignition system 200 with steps, resulting in a shorter time to reach the maximum spark length as compared to the embodiment without steps. An inclined section 270 with steps was selected for the following experiments.

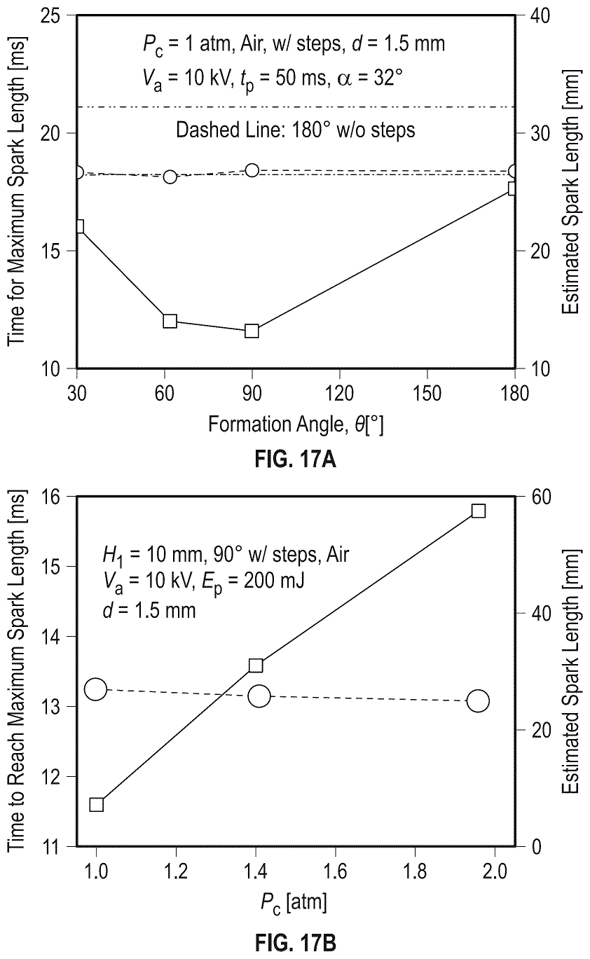

FIGS. 17A-17B are charts showing the effects of slanted angle and pressure on the time to reach maximum spark length and the estimated spark length according to one or more embodiments. The time to reach the maximum spark length in milliseconds (ms) is shown along the left vertical axis, and the estimated spark length in millimeters (mm) is shown along the right vertical axis. Results for the times to reach the maximum spark length are plotted as squares and results for the estimated spark lengths are plotted as circles.

In FIG. 17A, results are shown for various formation angles. An embodiment with an inclined section 270 without steps at a formation angle θ=180° was used to obtain a baseline value for the time to reach a maximum spark length, represented by a dotted horizontal line that does not intersect with any shapes. Since the height and diameter of the slanted geometry remained the same in all embodiments tested for FIG. 17A, the maximum spark lengths are also relatively constant regardless of the formation angle.

When embodiments with different formation angles were tested, the time to reach the maximum spark length varied. As the formation angle increased from 30° to 90°, the time for maximum spark length decreased. The shortest time found, 11.6 ms, corresponded to a slanted angle of 90°. As the formation angle increased from 90° to 180°, the time for maximum spark length increased. A formation angle of 90° was selected for the following experiments.

In FIG. 17B, results are shown for various pressures in the CVCC. Since the height and diameter of the slanted geometry remained the same in all embodiments tested for FIG. 17B, the maximum spark lengths (plotted as circles) are seen to remain relatively constant regardless of the slanted angle.

The time to reach the maximum spark length was found to increase with pressure, going from 11.6 ms at 1 atm to 13.6 ms at 1.4 atm to 15.8 ms at 1.96 atm. This trend may be explained by considering the increased air density and, consequently, increased air resistance present with increased pressure.

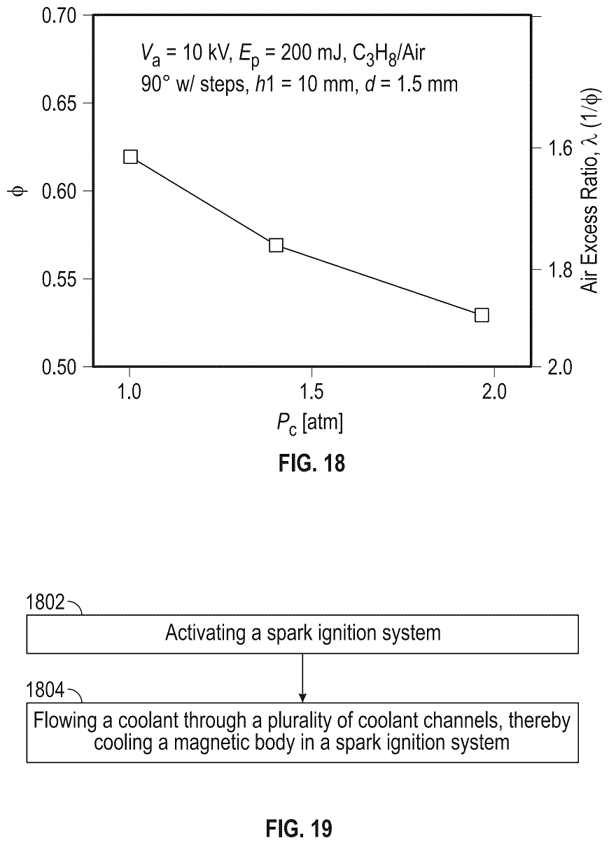

FIG. 18 is a chart showing the effect of pressure on the limits of lean combustion of a spark ignition system 200 according to one or more embodiments. At P_{c}=1.00 atm, the spark is shown to ignite the mixture for φ>0.62 (λ<1.61), resulting in the highest lean propagation limit among tested pressures. For P_{c}=1.40 and 1.96 atm, the φ (λ) was further extended to 0.57 (1.75) and 0.53 (1.89), respectively, caused by an increase in the collision frequency and number density of the molecules.

FIG. 19 is a flowchart of a method for using a spark ignition system 200 according to one or more embodiments. In block 1802, a spark ignition system 200 is activated, such as by applying a high voltage to the terminal 210. In block 1804, a coolant is flowed through at least one coolant channel, thereby cooling a magnetic body 240 in the spark ignition system 200. In one or more embodiments, coolant may be flowed after heat has begun to build in the spark ignition system 200.

Embodiments of the present disclosure may provide at least one of the following advantages. The spark ignition system and spark ignition engine may rapidly increase the length of a spark discharge and a spark channel, thereby combusting a lean-burn mixture. The spark ignition system and spark ignition engine may also be capable of extending the length of spark discharge regardless of how operating conditions of the engine, such as ignition timing and fuel injection timing, affect the tumble flow. Additionally, the spark ignition system and spark ignition engine may overcome problems due to rotating a spark discharge by a magnetic force.

Although only a few example embodiments have been described in detail above, those skilled in the art will readily appreciate that many modifications are possible in the example embodiments without materially departing from this invention. In addition, many modifications will be appreciated by those skilled in the art to adapt a particular instrument, situation, or material to embodiments of the disclosure without departing from the essential scope thereof. Accordingly, all such modifications are intended to be included within the scope of this disclosure as defined in the following claims.

Furthermore, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

What is claimed:

1. A spark ignition system, comprising:
a terminal configured to receive power;
a center electrode electrically connected to the terminal and protruding into a combustion chamber;
an insulating body configured to insulate the center electrode;
a magnetic body configured to generate a magnetic force; and
a grounding body comprising a body section and an inclined section and configured to generate a spark discharge and further configured to transmit the magnetic force to the spark discharge, wherein the magnetic force is configured to rotate the generated spark discharge.

2. The spark ignition system of claim 1, wherein the grounding body is cylindrical.

3. The spark ignition system of claim 1, wherein the inclined section is inclined at an angle between 0° and 90°.

4. The spark ignition system of claim 1, wherein the inclined section is inclined at an angle between 30° to 45°.

5. The spark ignition system of claim 1, wherein the inclined section comprises a step.

6. The spark ignition system of claim 1, wherein at least one of the insulating body, the magnetic body, and the grounding body is radially disposed around the center electrode.

7. The spark ignition system of claim 1, wherein the insulating body is disposed adjacent to a first end of the terminal.

8. The spark ignition system of claim 1, wherein at least one of the magnetic body and grounding body is radially disposed around the insulating body.

9. The spark ignition system of claim 1, wherein the grounding body is disposed at a first end of the magnetic body.

10. The spark ignition system of claim 1, wherein the magnetic body is disposed outside a combustion chamber.

11. The spark ignition system of claim 1, wherein the grounding body is a metal material.

12. The spark ignition system of claim 1, further comprising a damper radially disposed around the spark ignition system and configured to prevent direct transmission of electromagnetic waves and vibrations from an engine.

13. The spark ignition system of claim 1, further comprising a plurality of coolant channels configured to direct a flow of coolant thereby cooling the magnetic body.

14. The spark ignition system of claim 13, wherein the plurality of coolant channels is disposed within the magnetic body.

15. A spark ignition engine, comprising:
a combustion chamber, comprising:
a cylinder block, and
a cylinder head; and
a spark ignition system inside the combustion chamber comprising:
a terminal configured to receive power,
a center electrode electrically connected to the terminal and protruding into a combustion chamber,
an insulating body configured to insulate the center electrode,
a magnetic body configured to generate a magnetic force, and
a grounding body comprising a body section and an inclined section and configured to generate a spark discharge and further configured to transmit the magnetic force to the spark discharge, wherein the magnetic force is configured to rotate the generated spark discharge.

16. The spark ignition engine of claim 15, further comprising a damper configured to prevent direct transmission of electromagnetic waves and vibrations from an engine.

17. The spark ignition engine of claim 15, further comprising a plurality of coolant channels configured to direct a flow of coolant thereby cooling the magnetic body.

18. A method for generating a spark in a spark ignition system, the method comprising:
applying a voltage to the spark ignition system, thereby generating the spark, wherein the spark ignition system comprises:
a terminal that receives power;
a center electrode electrically connected to the terminal and protruding into a combustion chamber;
an insulating body configured to insulate the center electrode;
a magnetic body configured to generate a magnetic force;
a plurality of coolant channels; and
a grounding body comprising a body section and an inclined section and configured to generate a spark discharge and further configured to transmit the magnetic force to the spark discharge, wherein the magnetic force is configured to rotate the generated spark discharge.

19. The method of claim 18, further comprising flowing a coolant through the plurality of coolant channels, thereby cooling the magnetic body.

20. The method of claim 18, wherein the spark ignition system further comprises a damper configured to prevent direct transmission of electromagnetic waves and vibrations from a engine.
